(19) United States
(12) Patent Application Publication
(10) Pub. No.: US 2006/0112332 A1
(43) Pub. Date: May 25, 2006

(54) System and method for design checking

(76) Inventors: Karl Kemp, Newport Beach, CA (US); Sinnie Kemp, Newport Beach, CA (US)

Correspondence Address: Karl Kemp, 128 Kings Place, Newport Beach, CA, 92663, US

(21) Appl. No.: 11/283,130

(22) Filed: Nov. 17, 2005

Related U.S. Application Data
(60) Provisional application No. 60/630,048, filed on Nov. 22, 2004.

(51) Int. Cl. G06F 17/00; G06F 15/00

(52) U.S. Cl. 715/530; 715/526; 715/512

(57) ABSTRACT

An aspect of the present invention is to provide a Virtual light table that is an implied or virtual representation of two plans overlaid onto one another. Embodiments of the invention allow the output to be configured and or filtered to allow various display modes and image combinations, and since the comparison is computer generated all differences noted will be output as specified and the user can select an appropriate display mode to view what they wish to see. Another aspect of the invention is that users can select plan files to compare at any stage of the drawing as they wish, and they can do batch compare or select regions of interest on each plan and conform (scale and translate) one image to be overlaid as needed onto another. Preferred embodiments allow for many annotation applications to be used to markup a comparison image giving users the ability to choose the best application for their needs. Another aspect of the invention is that the comparison may be displayed on a computer monitor so there is no need for prints and the time and expense involved creating them.

### CROSS-REFERENCE TO RELATED APPLICATIONS

The present Utility patent application claims priority benefit of the U.S. provisional application for patent No. 60/630,048 filed on Nov. 22, 2004 DESIGN CHECKING SYSTEM (Implicit Light Table) under 35 U.S.C. 119(e).

### FEDERALLY SPONSORED RESEARCH OR DEVELOPMENT

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to computer assisted drafting (CAD). More specifically, the invention relates to the comparison and annotation of CAD documents.

### BACKGROUND OF THE INVENTION

CAD is often used to design and document a model. A model is a virtual representation of most anything that can be built, from a screw to an airplane. The views of these models and the additional details created to elaborate them are referred to as documents or plans. The page size of these design documents is typically greater than 17″ by 22″ making it difficult to view an entire document on a computer screen at any acceptable detail to verify or check them. The advent of electronic document formats like PDF (Adobe) or DWF (AutoDesk) and the VIEWER applications (Adobe Acrobat or AutoDesk Composer) that support them has made it possible for designers to distribute their design documents electronically. Some viewers include annotation capabilities that allow a user to create notes and markups (ANNOTATION) directly on an electronic document (ANNOTATION CANVAS). It is now even possible to import these annotations back into specific design applications. Ultimately the challenge is document checking. In order to implement any design it must be fully developed and checked to verify that it can be built, and it meets all applicable standards. This process involves clients, several departments and/or governmental agencies (APPROVING AGENTS) that determine the conformance of design to the applicable specifications. When two documents are compared, the main concern is what has changed and if the changes comply with the approving agents requirements (annotations). Ideally, a single document that delineates the differences visually is desired.

In known methods of document comparison, the user is expected to create and assemble the documents into a collection (PDF file), which will be compared to create another difference document depicting differences only in a side-by-side manner with no ability to incorporate any annotations or markups created in the comparison program into the design model. Further, the base comparison method in the prior art is to create lookup tables (digests) of checksums (hashes) of document entities (marking operators) with a secondary method that renders bitmaps of specific areas of the document from which new lookup tables and checksums are created. It should be noted that this comparison method is intended to work with a letter or desktop publishing document such as those typically created in Microsoft Word.

The Adobe Solution is particularly poor for CAD documents because of the document dimensions, document organization, and printing methods. The physical dimensions of a CAD document are in most cases greater than 22″ wide by 17″ high making onscreen display of a side-by-side comparison unreadable. The difference between word processing documents and CAD design documents is how they are organized for output. Word processing documents have a direct relationship (page for page) between the source file and the output file. This direct relationship makes it possible to simply print to file knowing that if a difference is highlighted during comparison it can be related to the source file quickly. There is no one to one relationship in CAD the user must first setup the particular sheet of interest in the design package and then print it to a file and then add it to the final PDF document. This process is repeated for each sheet that is to be included in the PDF document. In effect the user must know the specific order and manually create and add each sheet to the comparison document.

Another known document comparison method is a light table. When using a light table to compare the user places one document on the top of another to visually determine areas of difference. The upper plan is generally the newer (SUBJECT PLAN) of plans being compared and the lower plan is typically a file copy of a previous known state of the design (REFERENCE PLAN). The light table allows direct overlay of one plan on another giving the user a direct comparison of the two plans. It also shows differences directly and allows accurate markup and annotation of the documents. However actual light tables have several disadvantages. To be able to see through, the plans should be printed on translucent materials such as Vellum or Mylar, which are very expensive. The scale of the plans must be the same. The process is interpretive, and the user may miss differences. Users need to have some experience and design knowledge interpreting the plans on a light table in order to achieve the desired results. Architectural or engineering sized drawings of 36″ by 48″ would require a large light table that would cost more and also take up valuable space. Only one plan can be checked at a time with an actual light table. The user must manually create the differences, and manually markup or annotate on a printed plan or in some form of annotation/markup utility such as Adobe Acrobat Professional or AutoDesk Composer, which are very specific applications that required specific file type. This also depends on if there is an electronic version of the plan available. Actual light tables depend on the accuracy of printed plans because of possible printing shift. The process is very time consuming and also causes physical strain on eyes and body of the user.

In view of the foregoing, there is a need for an improved method for comparing CAD documents that is easy to use, accurate, and can be viewed on a computer screen.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a flow chart of an exemplary design documentation process, in accordance with an embodiment of the present invention;

FIGS. 2a, 2b, 2c and 2d are exemplary design documents that illustrate the comparison of such documents, in accordance with an embodiment of the present invention. FIG. 2a is a new image of the design, referred to herein as the SUBJECT DOCUMENT. FIG. 2b is an old image of the design, referred to herein as the REFERENCE DOCUMENT. FIG. 2c is a COMPOSITE DOCUMENT showing the comparison between the REFERENCE DOCUMENT and the SUBJECT DOCUMENT. FIG. 2d is a MARKUP IMAGE showing an example of comparison and resulting markups;

FIG. 3 is a flowchart depicting the steps in a comparison function, in accordance with an embodiment of the present invention;

FIG. 4 is a flowchart that depicts an exemplary markup process, in accordance with an embodiment of the present invention; and

FIG. 5 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of techniques for implementing a design checking system are described.

A method for design checking of at least two design images is provided that, in one embodiment, includes steps for comparing an imported subject document with an imported reference document and steps for creating a composite document showing the comparison results between the reference document and the subject document.

Other embodiments of the present invention, optionally includes any combination of steps for generating a markup image showing the comparison and associated markups; and/or steps for extracting from a composite image file a changed item collection; and/or steps for performing a region of interest comparison; and/or steps for performing an interactive document comparison; and/or steps for performing a batch document comparison to create at least one difference set.

An aspect of the invention is that the comparison maybe displayed on a computer monitor so there is no need for prints and the time and expense involved creating them.

Yet other embodiments of the present invention provide means and a computer software product to implement some or all of the foregoing method embodiments.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

The preferred embodiment of the present invention is automated in a computer function, which offers several attendant capabilities, such as, without limitation: scales are already known for the project; differences are significantly less likely to be missed at least because they are highlighted; the user needs no knowledge of the process to achieve the desired results as long as they know the file names they are going to compare; the monitor's screen would take care of any drawing sizes; any design station with high resolution monitor can be used; the electronically created differences may be saved for future reference or printed for manual markup; markup and/or annotation can be done right on screen then saved and imported back to the source design file; and the process is very quick, finding the differences typically within seconds.

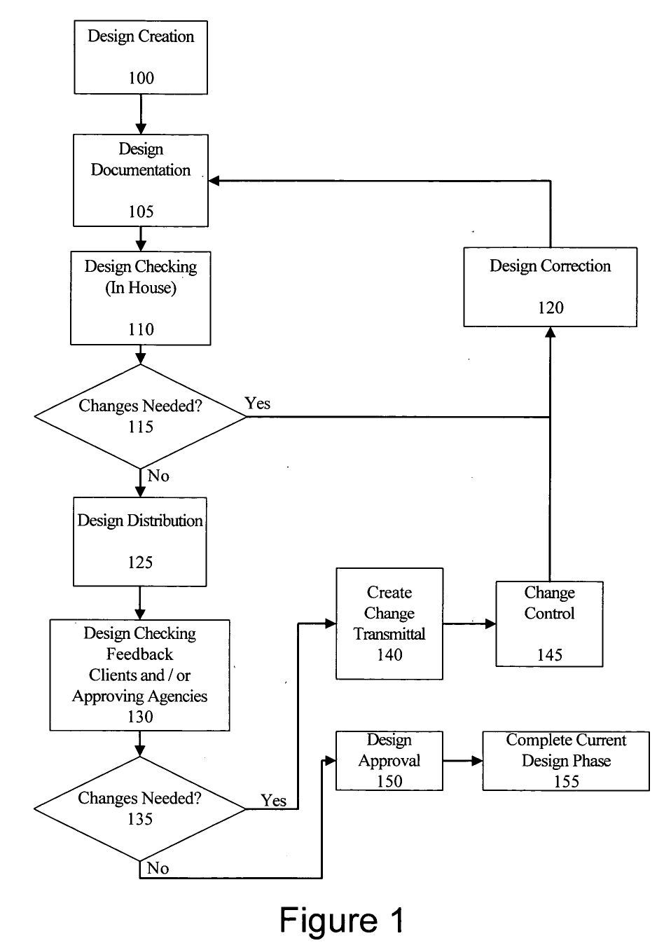

FIG. 1 shows a flow chart that depicts an exemplary design documentation process, in accordance with an embodiment of the present invention. The design model and the design documentation set (plan set) are defined in step 100. In the present embodiment, it is assumed that the documentation practices applicable to the particular design purpose have been followed. The plan set is created in step 105. The plan set is the actual description of the design model, and it is used to check, approve and eventually build the item that has been designed. The plan set is purpose specific since the design model undergoes several distinct approval stages with the plan set contents changing for each stage of the process. The process goes through two instances of design checking functions and changes needed functions because these functions are done both in-house and offsite. The first instance of design checking is done at step 110. This is the in-house check. If any changes need to be made at step 115, the system goes to step 120 where corrections are made. In the present embodiment, changes done in step 115 are the result of internal completeness checks. If no changes need to be made in step 115, the process moves ahead to step 125. In step 125 (Design Distribution) the plan set is transformed into the physical form or format, for example, without limitation, PDF, DWF, TIFF or plain paper that the various approving agencies and individual recipients require. In step 130 the system goes through the second checking function. Step 130 is the offsite check. The changes in step 135 may be requested changes from clients and/or approving agencies. The corrections, changes and approval conditions (markups and annotations) are collected and forwarded to the designer in step 140 in the form of a change order or transmittal. In the present embodiment, the Change Control Function, step 145 is the collection point for all change orders so that the client and designer can correlate, prioritize and approve them to be implemented in step 120. Once all conditions are met, the particular design phase is approved in step 150, and this phase is implemented in step 155. In some embodiments, subject and reference images can be created when normal documents such as, but not limited to, PDF or DWF are being created using simple to create macros that aggregate both functions into one. Also, subject and reference images can be created directly from PDF or DWF document files, so the user does not need to have a CAD package installed by using additional imaging and viewing toolkits such as, but not limited to, Atalasoft DotImage PDF Rasterize.

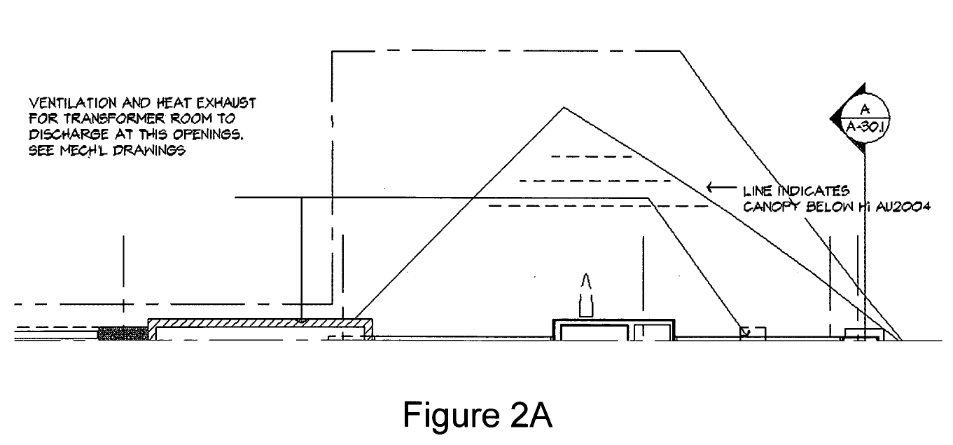

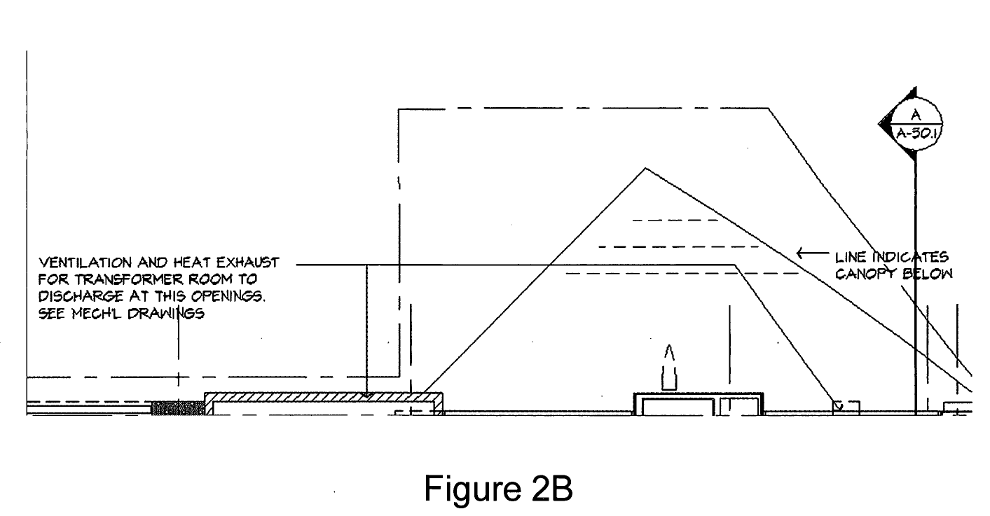

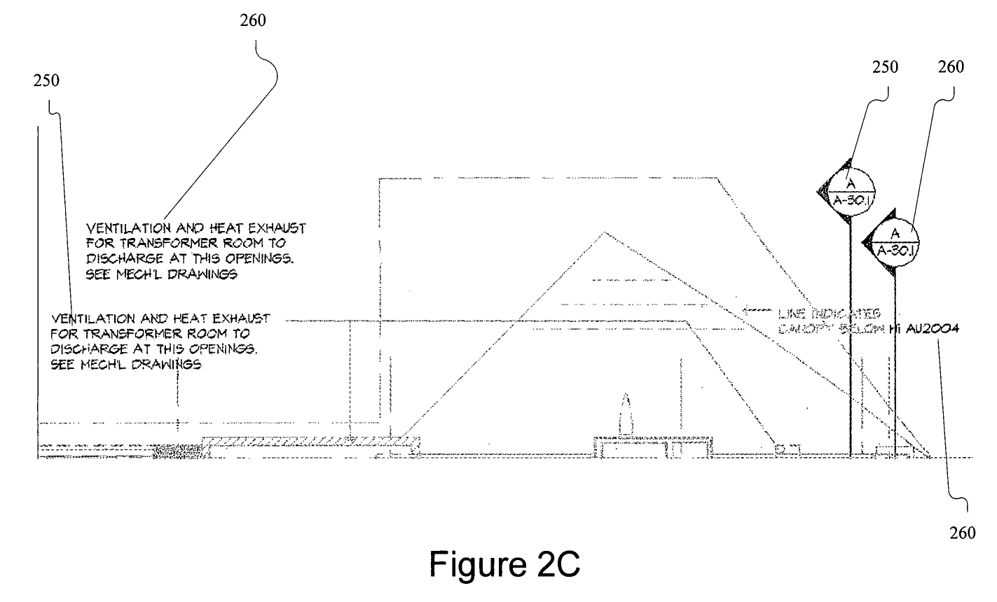

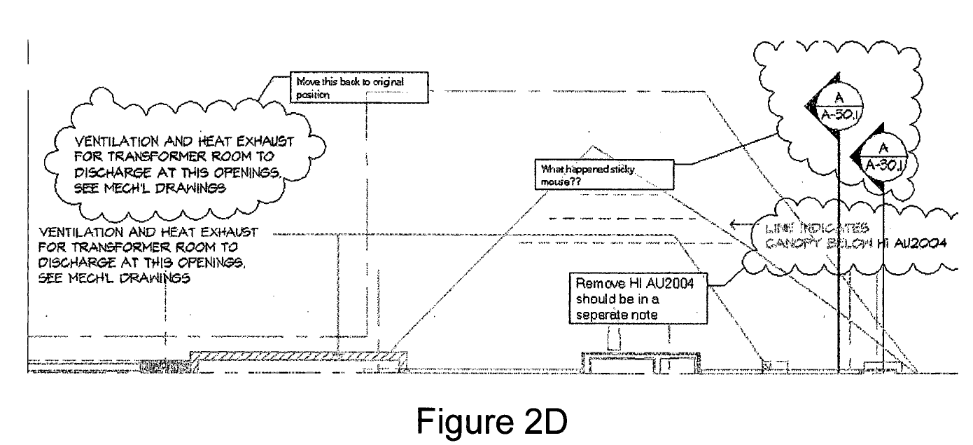

FIGS. 2a, 2b, 2c and 2d are exemplary design documents that illustrate the comparison of such documents, in accordance with an embodiment of the present invention. FIG. 2a is a new image of the design, referred to herein as the SUBJECT DOCUMENT. FIG. 2b is an old image of the design, referred to herein as the REFERENCE DOCUMENT. FIG. 2c is a COMPOSITE DOCUMENT showing the comparison between the REFERENCE DOCUMENT and the SUBJECT DOCUMENT. FIG. 2d is a MARKUP IMAGE showing an example of comparison and resulting markups. The composite document in FIG. 2c represents the Virtual Light Table image where all the information that is the same is displayed in a first color (e.g., light gray), all that was deleted is displayed in a second color (e.g., red) and all that is new is displayed in a third color (e.g., black). Although not shown in color as in the preferred embodiment, in the example shown, a drawing element 250 is marked as deleted drawing element 260 is marked as new, and all other drawing elements that are the same are grayed out. In the preferred embodiment, all differences are highlighted in one color, and composite image can be configured to a user specified color scheme. Alternatively, instead of using a color scheme, any suitable means to distinguish same, deleted, and new comparison information may be implemented in alternative embodiments depending upon the needs of the particular application; for example, without limitations, using textures, broken lines, etc. In the present example, the three changes that were made can be seen easily, even at a reduced scale. The single composite document shows both versions of the document, and, using simple functions that change the color palette, the user can switch between the common, new and deleted information quickly. Composite documents can have the subject and reference image file information imprinted on them, for example, without limitation, a fax header showing specific transmission details, or stored as metadata (computer readable) in the image header (format specific), making it easy to identify the subject and reference documents that relate to the particular composite image. The adaptable comparison allows users to specify how elements are compared.

In this example, the subject document is a 36 by 48, 1-bit Tiff at 100 dpi or 3600 by 4800 pixels of information and the composite document is a 36 by 48, 8-bit Tiff at 100 dpi. If the composite document is printed at eleven inches by seventeen inches on a color printer it produces an excellent, manageable and cost effective hardcopy verification of what has been changed. Also, in the present example, the reference document and subject document file sizes are approx 220 kBytes each and the resulting composite document is 340 kBytes, making storage a minor issue given the flexibility and results. FIG. 2d shows the actual differences between the two original documents, and what remains the same is in a gray tone. FIG. 2d shows what an annotation might look like, without limitation, using a commercially available annotation toolkit such as, but not limited to, Atalasoft DotAnnotate. The “clouded” areas and the associated text boxes ill blue are annotations.

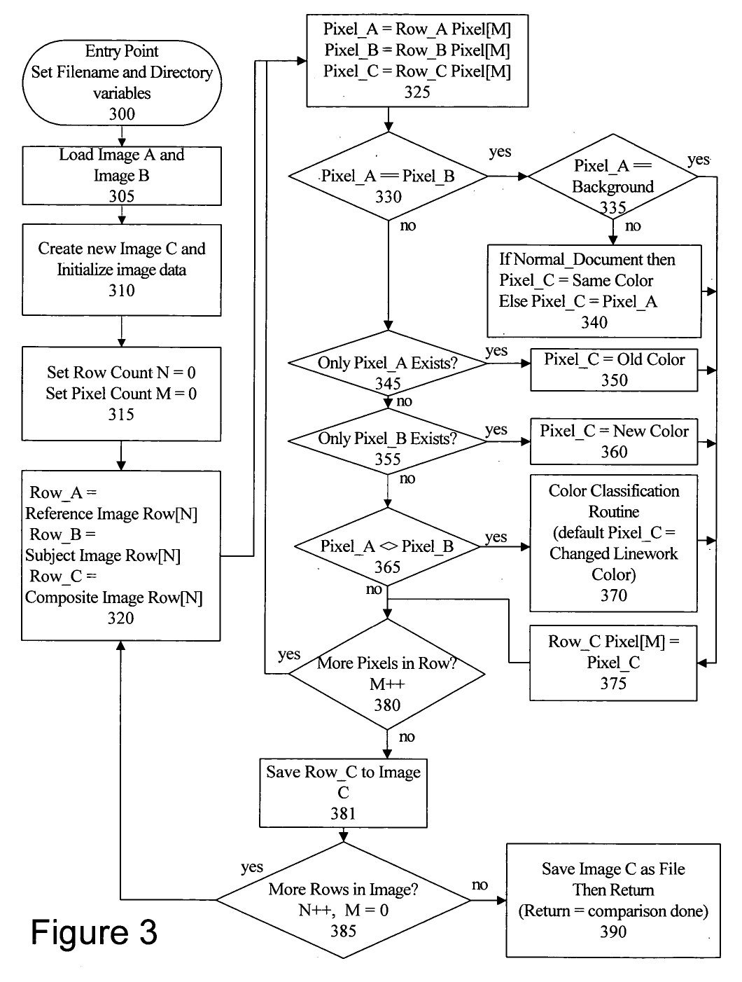

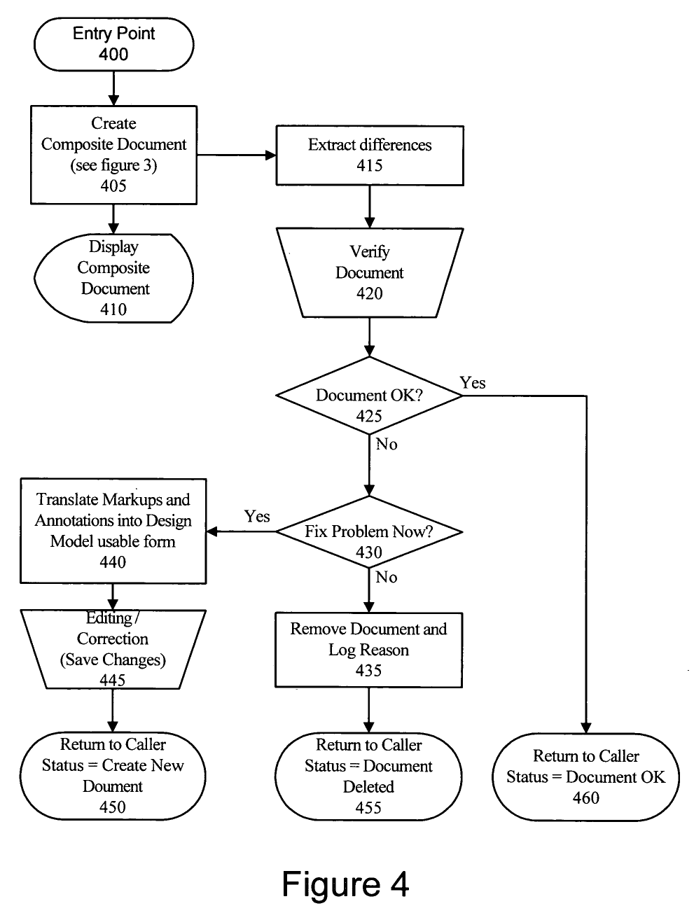

FIG. 3 illustrates a flowchart of exemplary steps for comparison function, in accordance with an embodiment of the present invention. The basic implementation of the present embodiment is a comparison of two 8 BitPerPixel, 4 BitPerPixel or 1 bitPerPixel images. Any image toolkit that can open and read image files and can specifically read and write raw image data may be used. One such toolkit, without limitation, is Atalsoft DotImage, which works with the Microsoft .net framework versions 1.0, 1.1, and 2.0. Those skilled in the art, in light of the present teachings, will recognize a multiplicity of alternate image toolkits that are appropriate for this application Such as, but not limited to Accusoft ImageGeal, LeadTools Document Imaging SDK, Pegasus ImagXpress, SnowBound RasterMaster, LeadTools Raster Imaging SDK and Catenary Victor Image Processing Library. In the present embodiment, the actual design can be implemented in a more traditional form. It is assumed that the user has created the reference and subject documents as required with the same settings. There is a known shortcoming in most CAD packages and especially AutoCAD that makes it possible to shift the printed document based on settings.

In the present embodiment, the comparison application is called CompareFunction.exe, and it is a console application. The application would minimally have, but is not limited to, the following arguments:

-r<ReferenceFileName> the fully qualified name of the reference file

-s<SubjectFileName> the fully qualified name of the subject file

-c<CompositeFileName> the fully qualified name of the composite file

Thus, the generalized form would be, without limitation:

CompareFunction-r ReferenceFileName-s SubjectFileName-c CompositeFileName

The user can then make changes as needed and then output the new state of the design document to a tiff image (SUBJECT document) using the same settings and method that created the REFERENCE document. The comparison result would be stored in the COMPOSITE document. In the present embodiment, the COMPOSITE document can be viewed by any tiff compatible image viewer, for example, without limitation, Microsoft Document Imaging, and annotated in any image annotation utility, such as, but not limited to Alias SketchBook by Alias Systems Corp, Notatelt by Blade Software, TiffViewer by BlackIce.

In alternate embodiments, the images that will be compared can be output in several ways for purposes of illustration. In the present embodiment, the simplest method is used, a Tiff Printer Driver. There are several versions of Tiff Printer Drivers available, including, without limitation, TIFF-XChange by Docu-Track. Tiff Printer Driver By BlackIce, Zan Image Printer Driver by Zan1011.com and Universal Document Converter by Coder Group The user would have previously output the reference image to file at a suitable resolution, for example, without limitation, 100 dpi 1 bit BW. Then the subject image is output at the same settings as the reference and the required comparison documents are available. For usage, a simple command format may be, without limitation:

CompareThese (subject image) (reference image) (composite image name)

In light of the present teachings, those skilled in the art will recognize that there are several suitable imaging toolkits available, and that there are many alternate approaches to writing the code for this application. In the present embodiment, the application is built in Visual Studio 2003 as a console application with command line syntax as shown above. This implementation allows a simple batch file referred to herein as the compareThese program to be created with the appropriate command line arguments for all the files to be tested. Specifically, in this embodiment, Atalasoft DotImage and DotAnnotate were used to prove the concepts. Since the most common image format available from printer drivers that create high-resolution bitmap images is Tiff, a 1 bit Tiff produced at 100 dpi resolution is used as the minimum acceptable image format in the present embodiment, but any resolution or color depth would be acceptable. High-resolution output can be achieved with the present embodiment, for example without limitation, in normal mode (100 dpi) the system can accurately resolve differences of approx 0.02″. Resolutions can be specified for specific needs, for example, without limitation, the resolution can be set to be very accurate in order to resolve small differences. It is assumed that both the REFERENCE and SUBJECT images are stored on disk and they have been created using the same settings.

The entry point of the comparison function is step 300 where the filename and destination directory variables are set. In step 305, the COMPARISON FUNCTION loads both the REFERENCE and SUBJECT images into memory and it determines the dimensions of theses images in order to create a new COMPOSITE image of appropriate size. The COMPOSITE image is created in step 310. In the present embodiment, resolution color depth is set at 256 colors. The values of all pixels in COMPOSITE image are also initialized to the value of the background color in step 310. In step 315 the function then initializes the loop variables N=0 (Row Counter) and M=0 (Pixel Counter) the function also allocates memory storage for Row_A, Row_B and Row_C to store the number of pixels in a row of the Reference, Subject and Composite images respectively. Then the functions in step 320 are executed for each row in the SUBJECT and REFERENCE images. Then the functions in step 325 are executed for each pixel value in Row_A and Row_B. In the present embodiment, the function in step 320 will load Row_A from Image_A (Reference) and load Row_B from Image_B (Subject) and load Row_C from Image_C (Composite), and the function in step 325 will get a Pixel from each Row. In step 330, if Pixel_A color value equals Pixel_B color value the function proceeds to step 335, if not, the function goes to step 345. In step 335, if Pixel_A color value equals the background color value, then the function goes to step 375, if not, the function proceeds to step 340 where if the Normal_Document Boolean flag is true then Pixel_C is set to the same color otherwise Pixel_C color value is set to the color value of Pixel_A, and the function goes to step 375. In step 345, if only Pixel_A exists (determined by testing if the Pixel_B color value equals the background color value), the function proceeds to step 350, if not the function goes to step 355. In step 350, Pixel_C color value is set to the old color value then the function goes to step 375. In step 355, if only Pixel_B exists (determined by testing if the Pixel_A color value equals the background color value), the function proceeds to step 360 where the Pixel_C color value is set to new color value, if not, the function skips to step 365. In step 365, if Pixel_A color value does not equal Pixel_B, color value, the function goes to step 375. Step 370 is the color classification routine which by default will set the Pixel_C color value to the default Changed Linework Color (Yellow for instance). In step 375, the color value of Row_C Pixel[M] is set equal to the Pixel_C color value is implemented. In step 380, if there are more pixels in row increment M, the function returns to step 325 and the process is repeated for the remaining pixels. If there are no more pixels in row increment M, the function proceeds to step 381. In step 381 the function saves the pixel values in the Row_C memory buffer to the appropriate location (Row N location) in the Image_C memory buffer and proceed to step 385. In step 385, if there are more rows in image increment N, the function sets M=0 and returns to step 320. If there are no more rows in image increment N, the function proceeds to step 390 where the name and location of the SUBJECT and REFERENCE images are either stored in METADATA or imprinted on the COMPOSITE image which is then saved to the file name and directory location the user has specified. Also, a success or failure indication is returned to the calling function, and the function returns to caller.

In the present embodiment shown, the color classification routine in step 370 functions as a user configured color map. In the case of 1 Bit images this routine is never executed. By default when color images are compared the color value of Pixel_C is set to the configured value of Changed Linework Color (Yellow for instance) This function is most useful to determine changes in line widths. When a design model is created in the design application on the computer screen, the line weights (or widths) are not displayed, but rather the lines are drawn in a screen color that corresponds to a particular printed line width. By outputting the design document in normal screen colors and mapping the line weights to a uniform or same value the resulting comparison image will show which line weights have changed. The user can specify how these differences are to mapped and in which color they will be displayed in the composite image.

In an alternate embodiment of the comparison function, the information can remain the same as it was printed. This allows the user to see the composite image as the designer had intended it to be viewed with only the differences being displayed in the configured color values. However, it should first be verified that the Changed Linework color, Old color and New color values are not duplicated in the Palette_A and/or Palette_B.

FIG. 4 is a flowchart that illustrates an exemplary markup process, in accordance with an embodiment of the present invention. In the present embodiment, step 400 is the entry point. In step 405, the composite document is created from the comparison of subject and reference documents. In step 410, the composite document is displayed. The differences between the subject and reference documents are extracted in step 415. In step 420 the changes are verified, and markup/annotations are created on the composite document in an annotation application. Step 420 is a manual process, not done in the scope of comparison. In step 425, if the design document is acceptable the process may go to step 460 and the process returns to the caller that the document is OK. If the design document is not acceptable in step 425, the decision to fix the problem right away or fix it later is made in step 430. In step 435, if the user decides not to fix the problem right away, the document is removed, the reason for not fixing the problem is logged, and the process skips to step 455 the process returns to the caller that the document has been removed and the caller can check the log for any reasons user may give. In step 440, if the user decides to fix the problem, the markups and the annotations are translated into the design model in usable form. Then, in step 445 the design application is entered to allow the user to edit and modify the design documents as required. Step 445 is a manual process, not done in the scope of comparison. Once changes are completed, the design document is saved to the design model source files and a new SUBJECT document needs to be created in step 450 the process returns to the caller that a new SUBJECT document needs to be created. This is also a manual process, not done in the scope of comparison. In the present embodiment, by utilizing a properly configured import utility, a comparison image (or some derivation) with the markups can be imported back into a design application such as, but not limited to, AutoCAD or MicroStation. Also, by utilizing a properly configured web service, users can receive annotations to previously created comparison images.

By way of example, and not limitations some embodiments of the present invention, may include a multiplicity of possible enhancements to the document comparison process, which produces the composite image; e.g., in an embodiment of the present invention, three different processes can be used to compare Design Documents, such as, a simple document comparison process, an interactive document comparison process, and a batch document comparison process.

An example of a simple document comparison process shown is in FIG. 3. In this embodiment, changed item collection can be extracted from a composite image file by utilizing any compatible commercial Raster to Vector Conversion SDK, for example without limitation the SDK offered by AlgoLAB or an open source implementation such as, but not limited to AutoTrace. Either of these implementations can output the vector differences to DXF. Since the format and structure of design documents can vary greatly, there are many variations. There are two simple comparison methods. The first is an overall comparison implemented with a dialog box that provides user interface objects to select the documents to compare and display the resulting composite image. The second method is a region of interest comparison. The user must select the files to compare and the actual regions of each to compare. The region of interest comparison can be done on images of different scale as long as the user can establish a scale relationship between the two images. One method to establish a scale relationship would be to select an entity such as, but not limited to a line that the user knows is contained in both images and is unchanged in both images also. This method can also be used to establish a base point to index the regions to compare. An example of an interactive comparison process is illustrated by way of example in FIG. 4. This process can be part of a final check process to verify all changes have been made.

In some embodiments, the batch document comparison process could be implemented as part of a batch document creation process to create the subject documents that will be used for comparison. This could be configured to produce a collated set of composite images, which can be viewed on screen or printed. The user can also elect to have the changed item file set (input to the markup and annotation package) produced for each composite image by the raster to vector conversion method defined above. Utilizing a properly configured database application, users can trace comparison output images that have appropriately stored meta data.

In some other embodiments, the design may further incorporate an Application Programming Interface (API) to allow users to adapt, extend, and customize the functionality of the application as would be appropriate in currently accepted design practices. This would be implemented as a Component Object Model interface (COM).

In yet other embodiments, by using available virtual printer drivers, such as, but not limited to EMF Printer Driver by BlackIce, Virtual Printer Driver by TwoPilots and EMF Printer Driver by Tracker Software that can create easy to use vector formats such as, but not limited to, Enhanced MetaFiles (EMF), text and embedded images can be extracted and compared separately. Also, one file can be used to create multiple output formats. The user can save one EMF file and all normal printing can be accomplished using this file including, but not limited to, print to PDF, DWF, Tiff or a plotter, and when a comparison is needed, the appropriate image can be created making comparison simple to implement.

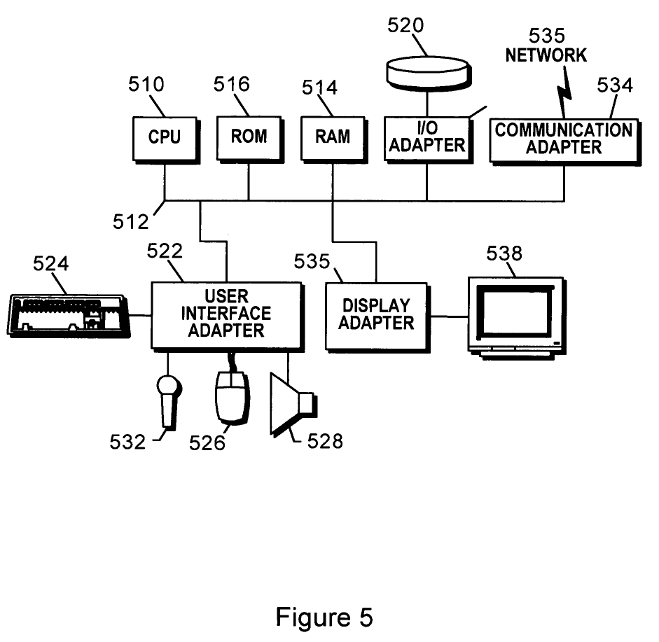

FIG. 5 illustrates a typical computer system that, when appropriately configured or designed, can serve as a computer system in which the invention may be embodied. The Figure illustrates a typical hardware configuration of a workstation in accordance with one embodiment having at least one central processing unit 510, such as a microprocessor, and a number of other units interconnected via a system bus 512.

The workstation shown in FIG. 5 includes a Random Access Memory (RAM) 514; Read Only Memory (ROM) 516; an I/O adapter 518 for connecting peripheral devices such as disk storage units 520 to the bus 512, a user interface adapter 522 for connecting a keyboard 524, a mouse 526, a speaker 528, a microphone 532, and/or other user interface devices such as track balls, touch-sensitive displays, transducer card readers, magnetic or paper tape readers, tablets, styluses, voice or handwriting recognizers, or other well-known input devices such as, of course, other computers (all not shown) to the bus 512; communication adapter 534 for connecting the workstation to a communication network 535 (e.g., a data processing network) and a display adapter 536 for connecting the bus 512 to a display device 538.

The system shown in the Figure may include any number of processors 502 (also referred to as central processing units, or CPUs) that are coupled to storage devices including primary storage, typically a random access memory (RAM), or a read only memory (ROM). CPU 510 may be of various types including microcontrollers and microprocessors such as programmable devices (e.g., CPLDs and FPGAs) and unprogrammable devices such as gate array ASICs or general purpose microprocessors. As is well known in the art, primary storage acts to transfer data and instructions uni-directionally to the CPU and primary storage is used typically to transfer data and instructions in a bi-directional manner. Both of these primary storage devices may include any suitable computer-readable media such as those described above. The mass storage device (e.g., disk storage units 520) are typically coupled bi-directionally via I/O adapter 518 to CPU 510 to provide additional data storage capacity and may include any of the computer-readable media described above. Mass storage device may be used to store programs, data and the like and is typically a secondary storage medium such as a hard disk (e.g., a hard-drive or FLASH drive acting as non-volatile RAM). It will be appreciated that the information retained within the mass storage device, may, in appropriate cases, be incorporated in standard fashion as part of primary storage as virtual memory. A specific mass storage device such as a CD-ROM may also pass data uni-directionally to the CPU.

Finally, CPU 510 optionally may be coupled to an external device such as a database or a computer or telecommunications or internet network using an external connection as shown generally at 512. With such a connection, it is contemplated that the CPU might receive information from the network, or might output information to the network in the course of performing the method steps described in the teachings of the present invention.

Having fully described at least one embodiment of the present invention, other equivalent or alternative methods of implementing a design checking system according to the present invention will be apparent to those skilled in the art. For example, although the forgoing embodiments were primarily exemplified in terms of CAD documents, those skilled in the art will readily recognize that the present invention may be readily adapted into alternative embodiments that likewise operate on any kind of images, and such alternative embodiments of the present invention are contemplated as being within the scope of the present invention. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method for design checking of at least two design images, the method comprising the following:
the step of importing a subject document;
the step of importing a reference document; and
steps for comparing the subject document with the reference document;
steps for creating a composite document showing the comparison results between the reference document and the subject document.

2. The design checking method of claim 1, further comprising steps for generating a markup image showing the comparison and associated markups.

3. The design checking method of claim 1, further comprising steps for extracting from a composite image file a changed item collection.

4. The design checking method of claim 1, further comprising steps for performing a region of interest comparison.

5. The design checking method of claim 1, further comprising steps for performing an interactive document comparison.

6. The design checking method of claim 1, further comprising steps for performing a batch document comparison to create at least one difference set.

7. A system for design checking of at least two design images, the system comprising the following:
means for importing a subject document;
means for importing a reference document; and
means for the comparing the subject document with the reference document;
means for creating a composite document showing the comparison results between the reference document and the subject document.

8. The design checking system of claim 7, further comprising means for generating a markup image showing the comparison and associated markups.

9. The design checking system of claim 7, further comprising means for extracting from a composite image file a changed item collection.

10. The design checking system of claim 7, further comprising means for performing a region of interest comparison.

11. The design checking system of claim 7, further comprising means for performing an interactive document comparison.

12. The design checking system of claim 7, further comprising means for performing a batch document comparison to create at least one difference set.

13. A design checking computer program product residing on a computer readable medium having a plurality of instructions stored thereon which, when executed by the processor, cause that processor to:
import a subject document;
import a reference document;
compare the subject document with the reference document; and
create a composite document showing the comparison results between the reference document and the subject document.

14. The design checking computer program of claim 13, further comprising means for generating a markup image showing the comparison and associated markups.

15. The design checking computer program of claim 13, further comprising means for extracting from a composite image file a changed item collection.

16. The design checking computer program of claim 13, further comprising means for performing a region of interest comparison.

17. The design checking computer program of claim 13, further comprising means for performing an interactive document comparison.

18. The design checking computer program of claim 13, further comprising means for performing a batch document comparison to create at least one difference set.

19. A computer program product according to claim 13, wherein the computer-readable medium is one selected from the group consisting of a data signal embodied in a carrier wave, an optical disk, a hard disk, a floppy disk, a tape drive, a flash memory, and semiconductor memory.
